(19) United States
(12) Patent Application Publication
(10) Pub. No.: US 2017/0196231 A1
(43) Pub. Date: Jul. 13, 2017

(54) PRODUCTION OF POLY ALPHA-1,3-GLUCAN FORMATE FOOD CASINGS

(71) Applicant: E I DU PONT DE NEMOURS AND COMPANY, Wilmington, DE (US)

(72) Inventors: Debora Flanagan Massouda, Wilmington, DE (US); Vindhya Mishra, Wilmington, DE (US); Matthew W. Geogre, Middletown, DE (US)

(21) Appl. No.: 15/320,593

(22) PCT Filed: Jun. 26, 2014
(86) PCT No.: PCT/US2015/037646

§ 371 Date: Dec. 20, 2016

Related U.S. Application Data
(60) Provisional application No. 62/017,507, filed on Jun. 26, 2014.

(51) Int. Cl. A22C 13/00; C08J 3/09; B29C 47/88; A23L 13/60; B29C 47/00; C08J 5/00; C08J 3/11

(52) U.S. Cl. CPC A22C 13/0013; C08J 5/00; C08J 3/095; C08J 3/11; A23L 13/65; B29C 47/0004; B29C 47/0026; B29C 47/8895; C08J 2305/00; A23V 2002/00; B29K 2005/00; A22C 2013/0023; A22C 2013/0086

(57) ABSTRACT

An extrusion process for making a poly alpha-1,3-glucan formate food casing is disclosed.

### CROSS-REFERENCE TO RELATED APPLICATION

This disclosure claims the benefit of priority of U.S. Provisional Application No. 62/017507, filed on Jun. 26, 2014, the entirety of which is herein incorporated by reference.

### FIELD OF THE INVENTION

This invention relates to poly alpha-1,3-glucan formate food casings, methods of their preparation and poly alpha-1,3-glucan formate coated food products.

### BACKGROUND

Glucose-based polysaccharides and their derivatives can be of potential industrial application.

Cellulose is a typical example of such a polysaccharide and is comprised of beta-1,4-D-glycosidic linkages of hexopyranose units. Cellulose is used for several commercial applications such as in manufacture of fibers, films (cellophane), sponges and food casings.

Casings are flexible, cylindrical or tubular containers used to contain food such as a sausage mix. Casings can be of natural origins or artificial.

Natural casings are obtained from animal intestines. Manufactured artificial casings are made of cellulose, collagen or synthetic materials.

Artificial casings, such as collagen, cellulose, plastic and extruded casings were developed at the beginning of the 20^{th} century when, in some countries, the supply of natural casings could no longer cope with the demand for such natural casings from the growing meat industry.

Following the development of highly automated sausage filling equipment, artificial casings proved to be better suited to those systems, mainly due to their uniformity.

Also from a hygienic point of view, there were certain advantages to artificial casings as the microbial contamination is negligible, refrigeration is not needed and there are not spoilage problems during transport and storage.

Artificial casings can be subdivided into two categories based on their structure and composition: 1) casings made of natural materials fall into two groups: a) casings made from organic plant material, namely, cellulose and b) casings made from animal by-products, namely, collagen; 2) casings made of synthetic substances deriving from thermoplastic materials including plastics or polymers such as polyamide, polypropylene or polyethylene.

Cellulose for industrial applications is derived from wood pulp. Specifically, cellulose, usually from cotton linters or wood pulp, is processed to make viscose, which is then extruded into clear, tough casings for making wieners and franks. Cellulosic viscose solutions are combined with wood pulp to make large diameter fibrous casings for bologna, cotto salami, smoke ham and other products sliced for sandwiches. This type is also permeable to smoke and water vapor. They can be flat or shirred, depending on application, and can be pretreated with smoke, caramel, color or other surface treatments.

Solutioning of cellulose is a difficult procedure. For production of objects from regenerated cellulose, the most commonly used process for dissolution of cellulose is the ‘viscose process’ where the cellulose is converted to cellulose xanthate made by treating a cellulose compound with sodium hydroxide and carbon disulfide. The use of this process involves toxic chemicals and significant environmental costs. Industry is seeking an alternative to the viscose process because of the difficulties in handling carbon disulfide.

In addition to the toxicity of carbon disulfide, tube-making processes have the specific problem of removing the carbon disulfide gas that evolves during coagulation and collects in the middle of the tube. While a viscose flat-film process can run continuosly even while carbon disulfide is removed, a viscose tube process must be intermittently interrupted to puncture the tube for removal of carbon disulfide, the gas that collects inside the tube.

Amongst polysaccharide polymers, glucan polymers, with alpha-1,3-glycoside linkages, have been shown to possess significant advantages. U.S. Pat. No. 7,000,000 disclosed preparation of a polysaccharide fiber comprising a polymer with hexose units, wherein at least 50% of the hexose units within the polymer were linked via alpha-1,3-glycoside linkages, and a number average degree of polymerization of at least 100. A glucosyltransferase enzyme from Streptococcus salivarius (gtfJ) was used to produce the polymer. The polymer formed a solution when it was dissolved in a solvent or in a mixture comprising a solvent. From this solution continuous, strong, cotton-like fibers, highly suitable for use in textiles, were spun and used.

As is discussed herein, it has been found that food casings composed of a polysaccharide glucan polymer can be made without toxic chemicals such as carbon disulfide.

### SUMMARY

In a first embodiment, the disclosure concerns a process for making a poly alpha-1,3-glucan formate food casing comprising: (a) dissolving poly alpha-1,3-glucan in a solvent composition comprising formic acid to provide a solution of poly alpha-1,3-glucan formate; (b) extruding the solution of poly alpha-1,3-glucan formate into a coagulation bath to make a tube-shaped wet gel; (c) optionally, washing the tube-shaped wet gel with water; and (d) removing the water from the tube-shaped wet gel to form a poly alpha-1,3-glucan formate food casing.

In a second embodiment, the disclosure concerns the coagulation bath comprises water.

In a third embodiment, the disclosure concerns the water contains a dilute aqueous base.

In a fourth embodiment, the disclosure concerns the solution of poly alpha-1,3-glucan formate in (b) of the first embodiment is coextruded over an extruded food product into a coagulation bath to make a tube-shaped wet gel covering an extruded food product.

In a fifth embodiment, the disclosure concerns a poly alpha-1,3-glucan formate food casing made according to a process comprising: (1) (a) dissolving poly alpha-1,3-glucan in a solvent composition comprising formic acid to provide a solution of poly alpha-1,3-glucan formate; (b) extruding the solution of poly alpha-1,3-glucan formate into a coagulation bath to make a tube-shaped wet gel; (c) optionally, washing the tube-shaped wet gel with water; and (d) removing the water from the tube-shaped wet gel to form a poly alpha-1,3-glucan formate food casing and (2) optionally, the solution poly alpha-1,3-glucan formate in (b) of the first embodiment is coextruded over an extruded food product into a coagulation bath to make a tube-shaped wet gel covering an extruded food product.

In a sixth embodiment, the disclosure concerns a food casing comprising poly alpha-1,3-glucan formate.

In a seventh embodiment, the disclosure concerns the food casing has a breaking stress from about 10 to about 100 MPa.

In an eighth embodiment, the disclosure concerns a food casing comprising poly alpha-1,3-glucan formate covering a food product.

### DETAILED DESCRIPTION

The terms “poly alpha-1,3-glucan”, “alpha-1,3-glucan polymer”, “glucan polymer” and “glucan” are used interchangeably herein. Poly alpha-1,3-glucan is a polymer where the structure of poly alpha-1,3-glucan can be illustrated as follows (where n is 8 or more):

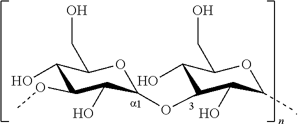

Poly alpha-1,3-glucan, useful for certain embodiments of the disclosed invention, can be prepared using chemical methods. Alternatively, it can be prepared by extracting it from various organisms, such as fungi, that produce poly alpha-1,3-glucan. Poly alpha-1,3-glucan useful for certain embodiments of the disclosed invention can also be enzymatically produced from renewable resources, such as sucrose, using one or more glucosyl-transferase (e.g., gtfJ) enzyme catalysts found in microorganisms as described in the co-pending, commonly owned U.S. Patent Application Publication No. 2013/0244288 which is herein incorporated by reference in its entirety.

The term “glucan formate” refers to a derivatized form of poly alpha-1,3-glucan wherein at least one monomer in poly alpha-1,3-glucan has one or more hydroxyl groups of poly alpha-1,3-glucan that have reacted to form a formate (-CHOO).

A method for producing food casings from a polymer solution involves extruding a polymer solution into a coagulation bath (with or without an air gap) followed by removal of the solvent composition. In order to prepare food casings in this manner, it is important that when the polymer solution is coagulated in the coagulation bath, then the tubular wet gel so formed needs to have enough wet gel strength to survive tensioning from the formation process. A process for making a poly alpha-1,3-glucan formate food casing begins with dissolving poly alpha-1,3-glucan in a formic acid and water solvent composition to provide a solution of poly alpha-1,3-glucan formate. When poly alpha-1,3-glucan is contacted with concentrated formic acid, one or more hydroxyl groups of poly alpha-1,3-glucan react to form a formate (—O—CH—). The poly alpha-1,3-glucan formate thus formed dissolves in the same reaction mixture, resulting in a one-pot production of a casting solution composed of a derivatized polymer, starting with underivatized glucan and formic acid.

The reaction proceeds even at room temperature. According to literature, cellophane raw material (wood pulp) does not readily react with formic acid to produce cellulose formate. This enhanced reactivity of poly alpha-1,3-glucan with formic acid offers significant advantages compared to cellulose esters like cellulose acetate. Cellulose esters have to be synthesized in a separate reaction, the product has to be recovered, dried and then redissolved in a different solvent system to produce a solution for film casting. This is not required for the production of poly alpha-1,3-glucan formate.

The glucan monomer has 3 functional —OH groups that can be derivatized to form the formate ester. This gives a maximum degree of substitution (DoS) of 3. The poly alpha-1,3-glucan is mixed into the solvent by application of shear to obtain clear solutions. At the initial stages of the reaction, the polymer granules swell. For high molecular weight polymer in solutions with polymer concentration of about 10 wt %, the swollen mixture has high viscosity and appears to be like a ‘gel’. Over time, most likely due to increased derivatization of the polymer, the solubility of the polymer in formic acid increases and the polymer dissolves into the solution to form a clear, free-flowing solution. The poly alpha-1,3-glucan is dissolved in the solvent composition at a concentration from about 5 wt % to about 20 wt %, more preferably about 6 wt % to about 15 wt % and most preferably about 7 wt % to about 10%. The glucan monomer has 3 functional groups that can be derivatized with formate. It should be noted that the process of the invention can produce a poly alpha-1,3-glucan formate film with a DoS of formate of 3 or less depending on reaction conditions. The DoS of formate comprises from at least about 0.1 to 3, preferably from at least about 0.2 to at most about 2.5, more preferably from at least about 0.3 to at most about 2.0 and most preferably from at least about 0.4 to about 1.5. The solubility of poly alpha-1,3-glucan formate in the solvent system is dependent on the composition of the solvent system as well as other factors. The lower the formic acid content in the solvent mixture, the longer the polymer takes to go into solution. The kinetics for dissolution of the glucan polymer is dependent on the relative ratio of formic acid to glucan in the starting mixture, the shear rate during mixing as well as the water content of the starting mixture. It may also depend on the initial particle size.

For example, an initial mixture composition of 10% polymer in a solvent composition of 90% formic acid, 10% water dissolves to form a clear solution in approximately 18 hours with overhead stirring. The degree of substitution of the polymer at this point is approximately 1.6 to 1.8. However, an initial mixture composition of 6% polymer in a solvent composition of 80% formic acid, 20% water may take more than 40 hours to form a solution with overhead stirring. The degree of substitution of the polymer at this time is approximately 0.9. It is believed that the polymer goes into solution once the degree of substitution of the polymer is high enough such that it can dissolve in the solvent composition.

The rate of substitution depends on the initial solvent composition as well. The solvent composition used to make the mixture comprises preferably at least about 80% formic acid and at most about 20% water and more preferably at least about 87% formic acid and at most about 13% water and most preferably at least about 90% formic acid and at most 10% water. However, formation of solutions with solvent compositions below 80% formic acid may be possible, but since the rate of substitution will likely be reduced, longer dissolution times or increasing the rate of reaction by heat or increased shear may be needed. As the reaction proceeds, the concentration of formic acid in the solution decreases while the concentration of water in the solution increases.

A process according to the present invention for making poly alpha-1,3-glucan formate food casings comprises: (a) dissolving poly alpha-1,3-glucan in a solvent composition to provide a solution of poly alpha-1,3-glucan formate; (b) extruding the solution of poly alpha-1,3-glucan formate into a coagulation bath to make a tube-shaped wet gel; (c) washing the tube-shaped wet gel with water; (d) optionally, plasticizing the tube-shaped wet gel with a plasticizer additive; and (e) removing the water from the tube-shaped wet gel to form a poly alpha-1,3-glucan formate food casing.

The poly alpha-1,3-glucan can have a DPw of at least about 400. The coagulation bath comprises water or other solutions, including dilute basic solutions, alcohols and salts such as sodium sulfate and sodium chloride. The solvent can be removed by evaporation, with or without heat.

The tube-shaped wet gel is washed with water until the bath has an approximately neutral pH.

The tube-shaped wet gel has a breaking stress of at least about 1.5 MPa, preferably about 2.0 MPa and most preferably about 5.0 MPa.

Water can be removed from the washed tube-shaped wet gel through evaporation to provide the poly alpha-1,3-glucan food casing.

The food casing has a breaking stress from about 10 to about 100 MPa.

Coextruded sausage casings are formed by extruding a polymer solution through a die together with an extruded meat (or other food) emulsion. This coextruded product is then typically passed through one or more coagulation baths and possibly through a dryer. This same process equipment is expected to be used for glucan formate solutions. Glucan in formic acid (with or without water) provides satisfactory coatings. Coagulation bath compositions are chosen to dehydrate and neutralize the glucan formate coating, leaving a wet gel covering the surface of the extruded food. Coagulation baths include water, dilute basic solutions, alcohols, and salts such as sodium sulfate and sodium chloride.

It was found that wet gels formed by coagulating films of these glucan formate solutions have wet gel breaking stress comparable to that of cellulose wet gels. With the correct balance of Mw and concentration, glucan formate flat wet gel breaking stress of at least 1.5 MPa can be made.

For the preparation of the food casing, a solution of poly alpha-1,3-glucan formate is prepared. The solvent composition is formic acid and water. Poly alpha-1,3-glucan is mixed into the solvent composition by application of shear. The concentration of the solution of poly alpha-1,3-glucan formate typically range from about 5 wt % to about 20 wt %.

A method for coextruding food casings from a polymer solution involves extruding a polymer solution through an annular coextrusion die to coat the exterior of an extruded food product, such as a sausage, into a coagulation bath (with or without an air gap) followed by removal of the solvent composition. In order to prepare extruded food products in this manner, a key requirement is when the polymer solution is coagulated in the coagulation bath, the tubular wet gel so formed has enough wet gel strength to survive twisting and tensioning in the remaining process steps.

It was discovered that moderate concentrations of glucan formate in solutions comprising formic acid provide coagulated wet gels with high strength. For example, a concentration of 6% of DPw 1250 and 12% of DPw 550 will provide wet gels strong enough for this application.

A process according to the present invention for making an extruded food product covered with a poly alpha-1,3-glucan formate food casing comprising: (a) dissolving poly alpha-1,3-glucan in a solvent composition comprising formic acid to provide a solution of poly alpha-1,3-glucan formate; (b) coextruding the solution of poly alpha-1,3-glucan formate onto the exterior of an extruded food product and into a coagulation bath to make an extruded food product covered with a poly alpha-1,3-glucan formate wet gel; (c) optionally, washing the poly alpha-1,3-glucan formate wet gel covered extruded food product with water; (d) removing the water from the wet gel coated extruded food product to form a poly alpha-1,3-glucan formate food casing covering the extruded food product.

For the coextruded layer comprising glucan formate dissolved in a solvent comprising formic acid, the coagulation bath comprises water. Dilute bases may be dissolved in the water.

The coextruded food product is washed with water until the bath has an approximately neutral pH.

The wet gel covering the interior extruded food product has a breaking stress of at least about 1.5 MPa, preferably about 2.0 MPa and most preferably about 5.0 MPa.

Water can be removed from the washed glucan formate wet-gel-covered extruded-food product through evaporation to provide an extruded-food product covered with a poly alpha-1,3-glucan formate food casing.

The food casing covering the extruded food has a breaking stress from about 10 to about 100 MPa.

Food casings of the present disclosure can be used to encase any type of processed meat and sausage type applications. Thus, these casings can have a small diameter or a large diameter. Examples of a variety of processed meats, include but are not limited to wieners, franks, hot dogs, sausages, bologna, cotto salami, smoke ham and other products sliced for sandwiches.

The present disclosure is directed toward a process for making a poly alpha-1,3-glucan formate food casing comprising: (a) dissolving poly alpha-1,3-glucan in a solvent composition comprising formic acid to provide a solution of poly alpha-1,3-glucan formate; (b) extruding the solution of poly alpha-1,3-glucan formate into a coagulation bath to make a tube-shaped wet gel; (c) optionally, washing the tube-shaped wet gel with water; and (d) removing the water from the tube-shaped wet gel to form a poly alpha-1,3-glucan formate food casing. The coagulation bath can comprise water. The water can contain a dilute aqueous base. The solution of poly alpha-1,3-glucan formate in (b) above can be coextruded over an extruded food product into a coagulation bath to make a tube-shaped wet gel covering an extruded food product.

The present disclosure is further directed toward a poly alpha-1,3-glucan formate food casing made according to a process comprising: (1) (a) dissolving poly alpha-1,3-glucan in a solvent composition comprising formic acid to provide a solution of poly alpha-1,3-glucan formate; (b) extruding the solution of poly alpha-1,3-glucan formate into a coagulation bath to make a tube-shaped wet gel; (c) optionally, washing the tube-shaped wet gel with water; and (d) removing the water from the tube-shaped wet gel to form a poly alpha-1,3-glucan formate food casing and (2) optionally, the solution poly alpha-1,3-glucan formate in (b) of the first embodiment is coextruded over an extruded food product into a coagulation bath to make a tube-shaped wet gel covering an extruded food product.

The present disclosure is still further directed toward a food casing comprising poly alpha-1,3-glucan formate. The food casing can have a breaking stress from about 10 to about 100 MPa.

The present disclosure is still further directed toward a food casing comprising poly alpha-1,3-glucan formate covering a food product.

### EXAMPLES

The present disclosure is further exemplified in the following Examples. It should be understood that these Examples, while indicating certain preferred aspects herein, are given by way of illustration only. From the above discussion and these Examples, one skilled in the art can ascertain the essential characteristics of the disclosed embodiments, and without departing from the spirit and scope thereof, can make various changes and modifications to adapt the disclosed embodiments to various uses and conditions.

The following abbreviations were used in the Examples

“DI water” is deionized water; “MPa” is megapascal; “DPw” is weight average degree of polymerization.

### General Methods

Degree of Polymerization (DPw) was determined by size exclusion chromatography (SEC). The molecular weight of a poly alpha-1,3-glucan can be measured as number-average molecular weight (Mₑ) or as weight-average molecular weight (M_{w}). The degree of polymerization can then be expressed as DP_{w} (weight average degree of polymerization) which is obtained by dividing M_{w} of the polymer by the weight of the monomer unit, or DPₙ (number average degree of polymerization) which is obtained by dividing Mₙ of the polymer by the weight of the monomer unit. The chromatographic system used was Alliance™ 2695 liquid chromatograph from Waters Corporation (Milford, Mass.) coupled with three on-line detectors: differential refractometer 410 from Waters, multiangle light scattering photometer Heleos™ 8+from Wyatt Technologies (Santa Barbara, Calif.) and differential capillary viscometer ViscoStar™ from Wyatt. The software packages used for data reduction were Empower™ version 3 from Waters (column calibration with broad glucan standard, DR detector only) and Astra version 6 from Wyatt (triple detection method without column calibration). Four SEC styrene-divinyl benzene columns from Shodex (Japan) were used—two linear KD-806M, KD-802 and KD-801 to improve resolution at low molecular weight region of a polymer distribution. The mobile phase was N,N′- Dimethyl Acetamide (DMAc) from J. T Baker, Phillipsburg, N.J. with 0.11% LiCl (Aldrich, Milwaukee, Wis.). The chromatographic conditions were as follows: temperature at column and detector compartments was 50 C, temperature at sample and injector compartments was 40 C, flow rate was 0.5 ml/min, injection volume was 100 μl. The sample preparation targeted 0.5 mg/mL sample concentration in DMAc with 5% LiCl, shaking overnight at 100 C. After dissolution, polymer solution can be stored at room temperature.

Thickness of the food casing was determined using a Mitutoyo micrometer, No. 293-831.

Preparation for Tensile Testing

Dry films were measured with a ruler and 2.5×7.6 cm strips were cut using a comfort loop rotary cutter by Fiskars, No. 195210-1001. The samples were then transported to the testing lab where room conditions were 65% relative humidity and 70° F.+/−2° F. The sample weight was measured using a Mettler balance model AE240.

Wet films were measured with a ruler and 2.5×7.6 cm strips were cut using a comfort loop rotary cutter by Fiskars, No. 195210-1001. The samples were then transported to the testing lab in a water bath where room conditions were 65% relative humidity and 70° F.+/−2° F. The wet sample weight was measured using a Mettler balance model AE240. The sample was left to soak in the water bath until right before testing.

Tensile Properties were measured on an Instron 5500R Model 1122, using 2.5 cm grips, and a 2.5 cm gauge length, in accordance with ASTM D882-09. Breaking stress was reported in MPa and maximum strain was reported in %.

### Preparation of Poly Alpha-1,3-Glucan

Poly alpha-1,3-glucan, using a gtfJ enzyme preparation, was prepared as described in the co-pending, commonly owned U.S. Patent Application Publication Number 2013-0244288 which was published on Sep. 19, 2013, the disclosure of which is incorporated herein by reference.

### Materials and General Methods

Formic acid was obtained from Sigma Aldrich (St. Louis, Mo.). Glycerol was obtained from Acros Chemicals.

Polymer Solution Preparation

Poly alpha-1,3-glucan polymer powder was dried in a vacuum oven at 40° C. overnight.

A glucan formate polymer solution containing 10% glucan with a DPw of 1250 was prepared by mixing the dried polymer powder with a solvent that contained 95% formic acid and 5% water.

### Examples 1a and 1b

### Process for Making a Poly Alpha-1,3-Glucan Formate Food Casing

There are multiple ways to make a poly alpha-1,3-glucan formate tube-shaped casing, two of them are described here. While a tubular casing can be made by extrusion through an annular die into a coagulation bath, due to lack of proper equipment alternate methods are demonstrated here.

Example 1a was prepared as follows. Poly alpha-1,3-glucan polymer (DPw 1250) was mixed in 95% formic acid and 5% water to make a 9 wt % polymer solution and stirred overnight. The polymer dissolved completely to make a clear, viscous solution of poly alpha-1,3-glucan formate. Ten to fifteen ml of this solution was poured onto a glass plate and spread to cast a thick cast wet film. A glass test tube (dimensions 2 cm diameter×11.5 cm long) was rolled over the cast wet film to transfer the cast wet film to the glass tube. The coated test tube was then immediately immersed in water for 2 minutes to coagulate the solution to form a tube-shaped wet gel. The coated tube with the tube-shaped wet gel was then immediately placed into consecutive baths of deionized water until the water pH was neutral. The coated tube with the tube-shaped wet gel was then placed in 10 wt % Glycerol (obtained from Acros Chemicals) solution for 10 mins. The tube-shaped wet gel was then loosened and removed from the test tube and allowed to dry. The final dry tube was 89+/−10 micron thick and was transparent.

Example 1b was prepared as follows. Poly alpha-1,3-glucan polymer (DPw 1250) was mixed in 95% formic acid and 5% water to make a 9 wt % polymer solution and stirred overnight. The polymer dissolved completely to make a clear, viscous solution of poly alpha-1,3-glucan formate. A glass test tube (dimensions 1 cm diameter×7.5 cm long) was dipped into this solution and removed to form a coating on the test tube. The coated test tube was then immersed in water for 2 minutes to coagulate the solution to form a tube-shaped wet gel. The coated tube with the tube-shaped wet gel was then immediately placed into consecutive baths of deionized water until the water pH was neutral. The tube-shaped wet gel was then loosened, removed from the test tube and allowed to dry. The final dry tube was 86.4+/−2.5 micron thick and was transparent.

Thus, the Examples above demonstrate a poly alpha-1,3-glucan formate food casing was made as a seamless tube with sufficient mechanical integrity and clarity according to the present disclosure.

### Permeable, Shrinking Casings

The following examples demonstrate that glucan casings allow water to permeate through and be removed from extruded food products. They also show that as the extruded food product shrinks, the casing shrinks with it to maintain a well-formed casing around the extruded food.

Individual hot dogs (8.0-8.5 g each) were placed on a skewer and dipped into a glucan formate solution, as indicated below. Hotdogs were weighted before and after dipping and again at regular intervals to measure weight loss due to water evaporation. As shown in the Table below, the hotdogs coated with glucan formate (at thicknesses that would be considered typical) lost the same amount of moisture as the uncoated hotdogs. This high degree of permeation would allow water to escape from the meat emulsion during cooking to create the desired texture. It was observed that the coatings shrank with the hotdogs and maintained a tight seal to the hotdogs as the water evaporated from the extruded meat.

### Comparative Examples A, B and C

### Uncoated Hotdogs

Comparative Examples A, B & C were uncoated hotdogs, attached to skewers, used here for controlled comparisons. Comparative Examples A & B were left in under ambient conditions, while Comparative Example C was sealed in a polyethylene bag. Weight losses after 7 days are shown in the Table.

### Example 2

### Process for Making a Poly Alpha-1,3-Glucan Formate Food Casing

Covering a Food Product

The hotdog on skewer in Example 2 was dipped in the following solution: 10% glucan (1250 DPw) in 95/5 formic acid/water. The coated hotdog was then immediately placed into water to coagulate the coating. The hotdog was hung under ambient conditions to dry. The 7-day weight loss is indicated in the Table below. This calculation was made assuming that the dry coating weight was 10% of the original wet coating weight. After the 7-day measurement was completed, the hotdog was sliced open and the coating was examined by microscope. It was found to have a thickness that varied between 63-95 microns. Weight losses after 7 days are shown in the Table.

TABLE 1
Weight Loss

| | | 7-Day |
|---|---|---|
| Example | Sample Description | Weight Loss |
| Comparative | Control #1-no coating | 44.8% |
| Example A | | |
| Comparative | Control #2-no coating | 45.2% |
| Example B | | |
| Comparative | Control #3-no coating, | 1.7% |
| Example C | sealed in PE bag | |
| Example 2 | Coated with glucan formate | 44.3% |

Thus, the Table shows that the poly alpha-1,3-glucan formate casings allow water to permeate through and be removed from food products. It was observed that as the food product shrinks, the casing shrinks with it to maintain a well-formed casing around the food product.

### Example 3

### Poly Alpha-1,3-Glucan Formate Food Casing Strength for Covering a Food Product

To demonstrate that a glucan formate layer co-extruded with an extruded food product into a coagulation bath would be strong enough to be pulled through a continuous process (including twisting and hanging while still wet), and without availability of standard equipment to co-extrude such products, flat wet gels of glucan formate were made using the following procedure, and mechanical properties of those flat wet gels were tested.

This 10% glucan (1250 DPw) in 95/5 formic acid/water solution was centrifuged to remove air bubbles. The solution was spread onto a glass plate by pouring a controlled amount of solution onto a glass plate, and then drawn down using a Meyer rod. The solution and the plate was immediately immersed in a water bath until a flat wet-gel was formed. In most instances, the flat wet gel removed itself from the glass. The flat wet gel was then placed in a new water bath to wash off residual formic acid. This washing process was repeated until the pH of the bath remained neutral after the flat wet gel was soaked for 10 minutes. The flat wet gel was removed from the bath. This process produced a smooth, flat wet gel with a thickness of 155 micron. The tensile strength was found to be max strain of 236% and a breaking stress of 6.6 MPa. The flat wet gel appeared colorless and transparent to the human eye while wet.

Thus, a poly alpha-1,3-glucan formate layer co-extruded with an extruded food product into a coagulation bath would be strong enough to be pulled through a continuous process.

What is claimed is:

1. A process for making a poly alpha-1,3-glucan formate food casing comprising:
(a) dissolving poly alpha-1,3-glucan in a solvent composition comprising formic acid to provide a solution of poly alpha-1,3-glucan formate;
(b) extruding the solution of poly alpha-1,3-glucan formate into a coagulation bath to make a tube-shaped wet gel;
(c) optionally, washing the tube-shaped wet gel with water; and
(d) removing the water from the tube-shaped wet gel to form a poly alpha-1,3-glucan formate food casing.

2. The process according to claim 1, wherein the coagulation bath comprises water.

3. The process according to claim 2, wherein the water contains a dilute aqueous base.

4. The process according to claim 1, further comprising the solution of poly alpha-1,3-glucan formate in (b) is coextruded over an extruded food product into a coagulation bath to make a tube-shaped wet gel covering an extruded food product.

5. A poly alpha-1,3-glucan formate food casing made according to claim 1 or claim 4.

6. A food casing comprising poly alpha-1,3-glucan formate.

7. The food casing according to claim 6, wherein the food casing has a breaking stress from about 10 to about 100 MPa.

8. A food casing comprising poly alpha-1,3-glucan formate covering a food product.
